(19) United States
(12) Patent Application Publication
(10) Pub. No.: US 2017/0037204 A1
(43) Pub. Date: Feb. 9, 2017

(54) THERMOPLASTIC COMPOSITE MATERIAL MADE FROM A SEMI-CRYSTALLINE POLYAMIDE AND METHOD FOR MANUFACTURING SAME

(71) Applicant: ARKEMA FRANCE, Colombes (FR)

(72) Inventors: Thierry BRIFFAUD, Caorches Saint Nicolas (FR); Gilles HOCHSTETTER, L'hay Les Roses (FR); Mathieu CAPELOT, Serquigny (FR)

(73) Assignee: ARKEMA FRANCE, Colombes (FR)

(21) Appl. No.: 15/304,575

(22) PCT Filed: Apr. 14, 2015
(86) PCT No.: PCT/FR2015/050997

§ 371 Date: Oct. 17, 2016

(30) Foreign Application Priority Data
Apr. 15, 2014 (FR) 1453355

(51) Int. Cl. C08J 5/04; B29C 70/52; B29C 70/44; C08G 69/36; B29C 70/48

(52) U.S. Cl. CPC C08J 5/043; C08G 69/36; B29C 70/48; B29C 70/443; B29C 70/52; C08J 2377/06; C08J 2477/06; B29K 2077/00

(57) ABSTRACT

A composition for a thermoplastic composite material, wherein said matrix thermoplastic polymer is a semi-crystalline polyamide polymer including amide units Z, 10T and 6T; wherein Z corresponds to an amide unit resulting from the condensation of at least one lactam or at least one C₆-C₁₄ amino acid, from the condensation of a diamine and a diacid X.Y, X and Y being at C₄-C₁₈, the molar rate of Z being 0.0%<Z≦30.0%; 10T is a majority amide unit resulting from the condensation of a C₁₀ diamine and terephthalic acid, provided in a molar rate of 40.0% to 95.0%; and 6T is an amide unit resulting from the condensation of a C₆ diamine and terephthalic acid, provided in a molar rate of 5.0% to 60.0%.

The invention relates to a composition of or for a thermoplastic composite material with a matrix of semicrystalline polyamide (PA) comprising amide units Z, 10T and 6T, said composition having a deflection temperature under load (HDT A) of less than 260° C. and a melting temperature Tm of less than or equal to 270° C., and also covers a process for manufacturing said composite material, in particular mechanical or structural parts based on said material, the use of the composition of the invention for composite material parts and also the composite part which results therefrom and for applications in the motor vehicle, electrical or electronics, railway, marine, road transport, wind power, sport, aeronautical and aerospace, construction, panel and leisure fields.

International application WO 2013/060976 describes a precursor composition and the use thereof in the molten state and which comprises: a) at least one prepolymer P(X)n of said thermoplastic polymer, comprising a molecular chain P having n identical reactive functions X at its ends, said prepolymer having a semi-aromatic and/or semi-cycloaliphatic structure, with X being a reactive function among: OH, NH₂ or COOH, with n ranging from 1 to 3, b) at least one chain extender comprising two identical functions Y, which are reactive with at least one of said functions X.

No mention is made of the HDT of this composition.

WO 2011/015790 describes compositions comprising from 45% to 95% by weight of a semi-aromatic copolyamide of formula A/X·T having a polydispersity index of less than 3.5, and from 5% to 55% by weight of at least one crosslinked polyolefin.

EP 2 586 585 describes thermoplastic composite materials having a Tg greater than or equal to 80° C., reinforced with synthetic fibers.

EP 1 988 113 describes a molding composition based on a 10T/6T copolyamide with:
40 to 95 mol % of 10T
5 to 40 mol % of 6T.
   These compositions have a melting point above 270° C. and, according to this patent, it was not known that the combination PA10T/6T in this specific molar ratio and comprising reinforcing fibers also had a surprisingly high HDT A, in particular above 260° C., preferentially above 270° C., in particular from 270° C. to 320° C. All the examples of compositions based on PA10T/6T in the proportions claimed, comprising reinforcing fibers, in particular glass fibers, describe HDT A values above 260° C.

It is also specified in this patent that 30 mol % of the monomers of the component (A) corresponding to 10T/6T can be substituted provided that no more than 30% of all the monomers are formed by lactams or amino acids, such as caprolactam, α,ε-aminocaproic acid, α,ε-aminononanoic acid, α,ε-aminoundecanoic acid, laurolactam and α,ε-aminododecanoic acid.

As it happens, it has been found by the applicant, entirely unexpectedly, that the compositions described in EP 1 988 113, in which the component (A) is substituted with up to 30% of an α,ε-amino acid or of a lactam, in particular an α,ε-aminoundecanoic acid, to give a polyamide of formula Z/10T/6T, in the presence of reinforcing fibers, have not only a melting point value below 270° C., but also an HDT A value much lower than 260° C.

The choice of this particular semicrystalline polyamide Z/10T/6T, as matrix of the composite material of the invention, has the advantage, compared with the others, of significantly improved mechanical performance levels, in particular hot mechanical performance levels, such as creep resistance or fatigue resistance. In addition, having a melting point above 200° C. has the advantage in the motor vehicle industry of being compatible with treatments by cataphoresis. Conversely, a melting point that is too high, in particular above 280° C., is on the other hand detrimental since it requires processing of the composite at higher temperatures with constraints in terms of molding material to be used (and associated heating system) and overconsumption of energy with, in addition, risks of heat degradation due to heating at temperatures higher than the melting temperature of said polyamide, with, as a consequence, an effect on the properties of the final thermoplastic matrix and of the composite which results therefrom. The crystallinity of said polymer must be as high as possible, but with a melting temperature Tm that is not too high (Tm≦270° C.) in order to optimize the mechanical performance levels and the crystallization rate and/or the crystallization temperature must be as high as possible, in order to reduce the molding time before ejection of the molded composite part with a selective choice of the composition of said semicrystalline polyamide.

Consequently, the subject of the present invention is the processing of novel specific compositions of thermoplastic composite, in particular based on semicrystalline polyamide, having a good compromise between high mechanical performance levels (mechanical strength), in particular hot mechanical performance levels, and easy processing.

This means that the objective is compositions that are easy to process with transformation and processing temperatures that are lower than those for other compositions of the prior art, with a more favorable overall processing energy balance, a shorter cycle time and a higher productivity. More particularly, the solution of the invention, in the case of reactive compositions, allows, using compositions based on semicrystalline reactive polyamide prepolymers, both fast reaction kinetics and fast crystallization kinetics with a shorter cycle time.

Consequently, the first subject of the invention relates to a specific composition of semicrystalline polyamide (PA) of formula for a thermoplastic composite material or a composition of thermoplastic composite material, with a thermoplastic matrix, said composition having an HDT A below 260° C., in particular below 240° C., in particular included from 210° C. to less than 240° C., as determined according to standard ISO 75 f (bars placed flat) method A (load 1.8 MPa), heating temperature ramp 50° C.h⁻¹ and a Tm of less than or equal to 270° C., in particular of approximately 260° C.

This composition may be reactive by means of prepolymers that are reactive with one another by condensation or with a chain extender by polyaddition and without elimination of volatile by-products. It may, alternatively, be a nonreactive composition based on polymer polyamides corresponding to the final polymer of the thermoplastic matrix. Said specific composition is based on the selective choice of amide units Z, 10T and 6T in specific molar proportions.

A second subject of the invention relates to a specific process for manufacturing said thermoplastic composite material and more particularly for manufacturing mechanical parts or structural parts based on said composite material.

Another subject of the invention relates to the use of the specific composition of PA of the invention for manufacturing a thermoplastic composite material of the same composition and more particularly mechanical or structural parts based on this material.

Another subject of the invention relates to the thermoplastic composite material which results from said composition for composite material.

Finally, the invention covers a mechanical part or structural part based on composite material obtained by means of the specific process of the invention or which results from the use of the specific composition of PA of the invention.

Consequently, the first subject relates to a composition for thermoplastic composite material or a composition of thermoplastic composite material, said composite material comprising reinforcing fibers or, in other words, a fibrous reinforcement and a thermoplastic matrix impregnating said fibers (or said fibrous reinforcement), said matrix being based on at least one thermoplastic polymer, with, with regards to said composition:
said matrix thermoplastic polymer being a semicrystalline polyamide polymer comprising amide units Z, 10T and 6T;
said composition comprising, in addition to said reinforcing fibers:
a) a reactive composition comprising or consisting of at least one reactive polyamide prepolymer (or oligomer, with oligomer and prepolymer meaning the same thing for the remainder of the text), said composition being a precursor composition of said polyamide polymer of said matrix,
or as an alternative to a)
b) a nonreactive composition of at least one polyamide polymer, including the polymer derived from the reactive composition a), said composition being that of said thermoplastic matrix,
and with:
said composition a) or b) comprising or consisting of one or more polyamides, including random or block copolyamides which are prepolymers (or oligomers) according to a) or which are polymers according to b) and which comprise amide units Z, 10T and 6T, selected as follows:
Z corresponding to an amide unit resulting:
   from the condensation of at least one C₆-C₁₄ amino acid or lactam,
   from the condensation of a diamine and of a diacid X.Y, X and Y being of C₄-C₁₈, in particular C₁₀-C₁₂,
the molar content of Z being: 0.0<Z: 30.0%,
10T is a major amide unit, resulting from the condensation of a C₁₀ diamine, in particular decanediamine, and of terephthalic acid, present in a molar content ranging from 40.0% to 95.0%,
6T is an amide unit, resulting from the condensation of a C₆ diamine, in particular hexanediamine, and of terephthalic acid, present in a molar content ranging from 5.0% to 60.0%,
   and under the condition that the sum of the molar contents Z+10T+6T is equal to 100%,
   said composition having a deflection temperature under load (HDT A) below 260° C., in particular included from 210° C. to less than 240° C., and a melting temperature Tm of less than or equal to 270° C., in particular less than or equal to 265° C., in particular less than or equal to 260° C.

Said composition is more particularly a composition for thermoplastic composite material. This means that it makes it possible to obtain a thermoplastic composite material.

Advantageously, the polyamide polymer of the invention is chosen from 6/10T/6T, 12/10T/6T or 11/10T/6T, in particular 11/10T/6T.

Advantageously, the polyamide polymer is chosen from 10.10/10T/6T, 12.10/10T/6T, 10.12/10T/6T and 12.12/10T/6T, preferentially 10.10/10T/6T and 10.12/10T/6T.

Advantageously, the molar proportion of Z is included from 5.0% to 20.0%, in particular from 9.0% to 20.0%, in particular from 10.0% to 20.0%, more preferentially from 8.0% to 15.0%.

Advantageously, the molar proportion of 10T is included from 55.0% to 65.0%, in particular from 55.0% to 60.0%, more preferentially from 60.0% to 65.0%.

Advantageously, the molar proportion of 6T is included from 15.0% to 60.0%, more preferentially from 20.0% to 45.0%, even more preferentially from 20.0% to 30.0%, in particular from 15.0% to 25.0%.

Advantageously, the molar proportion of Z is included from 5.0% to 20.0% and the molar proportion of 10T is included from 55.0% to 65.0% and the molar proportion of 6T is included from 15.0% to 60.0%.

Advantageously, the molar proportion of Z is included from 5.0% to 20.0% and the molar proportion of 10T is included from 55.0% to 65.0% and the molar proportion of 6T is included from 20.0% to 45.0%.

Advantageously, the molar proportion of Z is included from 5.0% to 20.0% and the molar proportion of 10T is included from 55.0% to 65.0% and the molar proportion of 6T is included from 20.0% to 30.0%.

Advantageously, the molar proportion of Z is included from 5.0% to 20.0% and the molar proportion of 10T is included from 55.0% to 65.0% and the molar proportion of 6T is included from 15.0% to 25.0%.

Advantageously, the molar proportion of Z is included from 5.0% to 20.0% and the molar proportion of 10T is included from 55.0% to 60.0% and the molar proportion of 6T is included from 15.0% to 60.0%.

Advantageously, the molar proportion of Z is included from 5.0% to 20.0% and the molar proportion of 10T is included from 55.0% to 60.0% and the molar proportion of 6T is included from 20.0% to 45.0%.

Advantageously, the molar proportion of Z is included from 5.0% to 20.0% and the molar proportion of 10T is included from 55.0% to 60.0% and the molar proportion of 6T is included from 20.0% to 30.0%.

Advantageously, the molar proportion of Z is included from 5.0% to 20.0% and the molar proportion of 10T is included from 55.0% to 60.0% and the molar proportion of 6T is included from 15.0% to 25.0%.

Advantageously, the molar proportion of Z is included from 5.0% to 20.0% and the molar proportion of 10T is included from 60.0% to 65.0% and the molar proportion of 6T is included from 15.0% to 60.0%.

Advantageously, the molar proportion of Z is included from 5.0% to 20.0% and the molar proportion of 10T is included from 60.0% to 65.0% and the molar proportion of 6T is included from 20.0% to 45.0%.

Advantageously, the molar proportion of Z is included from 5.0% to 20.0% and the molar proportion of 10T is included from 60.0% to 65.0% and the molar proportion of 6T is included from 20.0% to 30.0%.

Advantageously, the molar proportion of Z is included from 5.0% to 20.0% and the molar proportion of 10T is included from 60.0% to 65.0% and the molar proportion of 6T is included from 15.0% to 25.0%.

Advantageously, the molar proportion of Z is included from 9.0% to 20.0% and the molar proportion of 10T is included from 55.0% to 65.0% and the molar proportion of 6T is included from 15.0% to 60.0%.

Advantageously, the molar proportion of Z is included from 9.0% to 20.0% and the molar proportion of 10T is included from 55.0% to 65.0% and the molar proportion of 6T is included from 20.0% to 45.0%.

Advantageously, the molar proportion of Z is included from 9.0% to 20.0% and the molar proportion of 10T is included from 55.0% to 65.0% and the molar proportion of 6T is included from 20.0% to 30.0%.

Advantageously, the molar proportion of Z is included from 9.0% to 20.0% and the molar proportion of 10T is included from 55.0% to 65.0% and the molar proportion of 6T is included from 15.0% to 25.0%.

Advantageously, the molar proportion of Z is included from 9.0% to 20.0% and the molar proportion of 10T is included from 55.0% to 60.0% and the molar proportion of 6T is included from 15.0% to 60.0%.

Advantageously, the molar proportion of Z is included from 9.0% to 20.0% and the molar proportion of 10T is included from 55.0% to 60.0% and the molar proportion of 6T is included from 20.0% to 45.0%.

Advantageously, the molar proportion of Z is included from 9.0% to 20.0% and the molar proportion of 10T is included from 55.0% to 60.0% and the molar proportion of 6T is included from 20.0% to 30.0%.

Advantageously, the molar proportion of Z is included from 9.0% to 20.0% and the molar proportion of 10T is included from 55.0% to 60.0% and the molar proportion of 6T is included from 15.0% to 25.0%.

Advantageously, the molar proportion of Z is included from 9.0% to 20.0% and the molar proportion of 10T is included from 60.0% to 65.0% and the molar proportion of 6T is included from 15.0% to 60.0%.

Advantageously, the molar proportion of Z is included from 9.0% to 20.0% and the molar proportion of 10T is included from 60.0% to 65.0% and the molar proportion of 6T is included from 20.0% to 45.0%.

Advantageously, the molar proportion of Z is included from 9.0% to 20.0% and the molar proportion of 10T is included from 60.0% to 65.0% and the molar proportion of 6T is included from 20.0% to 30.0%.

Advantageously, the molar proportion of Z is included from 9.0% to 20.0% and the molar proportion of 10T is included from 60.0% to 65.0% and the molar proportion of 6T is included from 15.0% to 25.0%.

Advantageously, the molar proportion of Z is included from 10.0% to 20.0% and the molar proportion of 10T is included from 55.0% to 65.0% and the molar proportion of 6T is included from 15.0% to 60.0%.

Advantageously, the molar proportion of Z is included from 10.0% to 20.0% and the molar proportion of 10T is included from 55.0% to 65.0% and the molar proportion of 6T is included from 20.0% to 45.0%.

Advantageously, the molar proportion of Z is included from 10.0% to 20.0% and the molar proportion of 10T is included from 55.0% to 65.0% and the molar proportion of 6T is included from 20.0% to 30.0%.

Advantageously, the molar proportion of Z is included from 10.0% to 20.0% and the molar proportion of 10T is included from 55.0% to 65.0% and the molar proportion of 6T is included from 15.0% to 25.0%.

Advantageously, the molar proportion of Z is included from 10.0% to 20.0% and the molar proportion of 10T is included from 55.0% to 60.0% and the molar proportion of 6T is included from 15.0% to 60.0%.

Advantageously, the molar proportion of Z is included from 10.0% to 20.0% and the molar proportion of 10T is included from 55.0% to 60.0% and the molar proportion of 6T is included from 20.0% to 45.0%.

Advantageously, the molar proportion of Z is included from 10.0% to 20.0% and the molar proportion of 10T is included from 55.0% to 60.0% and the molar proportion of 6T is included from 20.0% to 30.0%.

Advantageously, the molar proportion of Z is included from 10.0% to 20.0% and the molar proportion of 10T is included from 55.0% to 60.0% and the molar proportion of 6T is included from 15.0% to 25.0%.

Advantageously, the molar proportion of Z is included from 10.0% to 20.0% and the molar proportion of 10T is included from 60.0% to 65.0% and the molar proportion of 6T is included from 15.0% to 60.0%.

Advantageously, the molar proportion of Z is included from 10.0% to 20.0% and the molar proportion of 10T is included from 60.0% to 65.0% and the molar proportion of 6T is included from 20.0% to 45.0%.

Advantageously, the molar proportion of Z is included from 10.0% to 20.0% and the molar proportion of 10T is included from 60.0% to 65.0% and the molar proportion of 6T is included from 20.0% to 30.0%.

Advantageously, the molar proportion of Z is included from 10.0% to 20.0% and the molar proportion of 10T is included from 60.0% to 65.0% and the molar proportion of 6T is included from 15.0% to 25.0%.

Advantageously, the molar proportion of Z is included from 8.0% to 15.0% and the molar proportion of 10T is included from 55.0% to 65.0% and the molar proportion of 6T is included from 15.0% to 60.0%.

Advantageously, the molar proportion of Z is included from 8.0% to 15.0% and the molar proportion of 10T is included from 55.0% to 65.0% and the molar proportion of 6T is included from 20.0% to 45.0%.

Advantageously, the molar proportion of Z is included from 8.0% to 15.0% and the molar proportion of 10T is included from 55.0% to 65.0% and the molar proportion of 6T is included from 20.0% to 30.0%.

Advantageously, the molar proportion of Z is included from 8.0% to 15.0% and the molar proportion of 10T is included from 55.0% to 65.0% and the molar proportion of 6T is included from 15.0% to 25.0%.

Advantageously, the molar proportion of Z is included from 8.0% to 15.0% and the molar proportion of 10 OT is included from 55.0% to 60.0% and the molar proportion of 6T is included from 15.0% to 60.0%.

Advantageously, the molar proportion of Z is included from 8.0% to 15.0% and the molar proportion of 10T is included from 55.0% to 60.0% and the molar proportion of 6T is included from 20.0% to 45.0%.

Advantageously, the molar proportion of Z is included from 8.0% to 15.0% and the molar proportion of 10T is included from 55.0% to 60.0% and the molar proportion of 6T is included from 20.0% to 30.0%.

Advantageously, the molar proportion of Z is included from 8.0% to 15.0% and the molar proportion of 10T is included from 55.0% to 60.0% and the molar proportion of 6T is included from 15.0% to 25.0%.

Advantageously, the molar proportion of Z is included from 8.0% to 15.0% and the molar proportion of 10T is included from 60.0% to 65.0% and the molar proportion of 6T is included from 15.0% to 60.0%.

Advantageously, the molar proportion of Z is included from 8.0% to 15.0% and the molar proportion of 10T is included from 60.0% to 65.0% and the molar proportion of 6T is included from 20.0% to 45.0%.

Advantageously, the molar proportion of Z is included from 8.0% to 15.0% and the molar proportion of 10T is included from 60.0% to 65.0% and the molar proportion of 6T is included from 20.0% to 30.0%.

Advantageously, the molar proportion of Z is included from 8.0% to 15.0% and the molar proportion of 10T is included from 60.0% to 65.0% and the molar proportion of 6T is included from 15.0% to 25.0%.

Advantageously, Z corresponds to an amide unit resulting from the condensation of a C₁₁ amino acid.

Advantageously, the polyamide polymer of the invention is 11/10T/6T in which the proportion of unit 11 is included from 5.0% to 20.0%, in particular from 9.0% to 20.0%, in particular from 10.0% to 20.0%, more preferentially from 8.0% to 15.0% and the proportion of 10T is included from 55.0% to 65.0%, in particular from 55.0% to 60.0%, more preferentially from 60.0% to 65.0% and the proportion of 6T is included from 15.0% to 60.0%, more preferentially from 20.0% to 45.0%, even more preferentially from 20.0% to 30.0%, in particular from 15.0% to 25.0%.

With regard to the reactivity or non-reactivity of said polyamide composition, according to a first option, said polyamide composition may be a nonreactive composition according to b). This means that said composition is the same as that of the matrix (polyamide) polymer of said composite, since there is an absence of reaction in this composition, which remains stable and unchanging in terms of molecular weight when it is heated for the processing of the composite material of the invention. The characteristics of the polyamide polymer in this composition are the same, with Tm as already defined above, as those of the final polymer, which is the semicrystalline polyamide obtained by means of a reactive composition a) (see below), said polymer constituting by definition said thermoplastic matrix of said composite. The polyamides according to b) are obtained by conventional polycondensation reaction from the monomer components which are amino acids or lactams, hexamethylenediamine, decanediamine and terephthalic acid, with the proportion and nature of the monomers being chosen according to the proportions desired in the matrix polymer of the composition of the invention.

The number-average molecular weight Mn of said final (polyamide) polymer of the thermoplastic matrix of said composition is preferably in a range of from 10 000 to 40 000, preferably from 12 000 to 30 000. These Mn values can correspond to inherent viscosities greater than or equal to 0.8. These polyamides according to composition b) are nonreactive, either because of the low content of reactive (residual) functions present, in particular with a content of said functions <120 meq/kg, or because of the presence of end functions of the same type at the chain end which are therefore nonreactive with one another, or because of the modification and blocking of said reactive functions by a monofunctional reactive component, for example for the amine functions by modification reaction with a monoacid or a monoisocyanate and for carboxy functions by reaction with a monoamine. When said final matrix polymer is derived from a reactive prepolymer in a reactive precursor composition a), this reactive prepolymer has an Mn which is at least two times lower than that of said final matrix polymer.

According to a second option, said polyamide composition may be a reactive prepolymer composition according to a) and precursor or precursor composition of said polyamide polymer of said matrix of the composite.

In this second option, according to the reactive composition a), three more particular possibilities can be distinguished. According to a first possibility, said composition a) may comprise or consist of at least one reactive (polyamide) prepolymer bearing, on the same chain (i.e. on the same prepolymer), two end functions X′ and Y′, said functions being respectively coreactive with one another by condensation, with X′ and Y′ being amine and carboxy or carboxy and amine, respectively. According to a second possibility, said reactive composition a) may comprise or consist of at least two polyamide prepolymers which are reactive with one another and which each respectively bear two end functions X′ or Y′, which are identical (identical for the same prepolymer and different between the two prepolymers), said function X′ of a prepolymer being able to react only with said function Y′ of the other prepolymer, in particular by condensation, more particularly with X′ and Y′ being amine and carboxy or carboxy and amine, respectively. This condensation (or polycondensation) reaction can bring about the elimination of by-products. Said by-products can be eliminated by working preferably according to a process using an open-mold technology. In the case of a closed-mold process, a step of degassing, preferably under vacuum, the by-products eliminated by the reaction is present, in order to prevent the formation of microbubbles of the by-products in the final composite material, which (microbubbles) can affect the mechanical performance levels of said material if they are not eliminated in this way. According to a third option of reactive composition a), said composition a) or precursor composition a) may comprise or consist of:
a1) at least one prepolymer of said thermoplastic polyamide polymer (of the matrix) as already defined above with this prepolymer bearing n identical end reactive functions X₁, chosen from: —NH₂ (amine), —CO₂H (carboxy) and —OH (hydroxyl), preferably —NH₂ (amine) and —CO₂H (carboxy), with n being 1 to 3, preferably from 1 to 2, more preferentially 1 or 2, more particularly 2,
a2) at least one chain extender Y₁-A′-Y₁, with A′ being a hydrocarbon-based biradical of non-polymeric structure (neither polymer nor oligomer nor prepolymer), bearing 2 identical end reactive functions Y₁, reactive by polyaddition (without elimination of reaction by-product) with at least one function X₁ of said prepolymer a1), preferably having a molecular weight of less than 500 and more preferentially less than 400, in particular, Y₁ is chosen from: oxazine, oxazoline, oxazolinone, oxazinone, imidazoline, epoxy, isocyanate, maleimide, cyclic anhydride, in particular from: oxazine, oxazoline, oxazolinone, oxazinone, imidazoline, epoxy, maleimide and cyclic anhydride.

NH₂ (amine) signifies a primary and secondary amine.

In the latter case (third option), the semicrystalline structure of said polyamide polymer of the matrix of said composite is essentially provided by the structure of said prepolymer a1) which is also semicrystalline.

As suitable examples of extenders a2) as a function of the functions X1 borne by said semicrystalline polyamide prepolymer a1), mention may be made of the following:
when X₁ is NH₂ or OH, preferably NH₂:
   either the chain extender Y₁-A′-Y₁ corresponds to
      Y₁ chosen from the groups: maleimide, isocyanate which is optionally blocked, oxazinone and oxazolinone, and cyclic anhydride, preferably oxazinone and oxazolinone, in particular from maleimide, oxazinone and oxazolinone, and cyclic anhydride, preferably oxazinone and oxazolinone
   and
      A′ is a carbon-based spacer or a carbon-based radical bearing the reactive functions or groups Y₁, chosen from:
         a covalent bond between two functions (groups) Y₁ in the case where Y₁=oxazinone and oxazolinone or
         an aliphatic hydrocarbon-based chain or an aromatic and/or cycloaliphatic hydrocarbon-based chain, the latter two comprising at least one optionally substituted ring of 5 or 6 carbon atoms, with optionally said aliphatic hydrocarbon-based chain optionally having a molecular weight of 14 to 200 g·mol⁻¹
   or the chain extender Y₁-A′-Y₁ corresponds to Y₁ which is a caprolactam group and to A′ which can be a carbonyl radical such as carbonyl biscaprolactam or to A′ which can be a terephthaloyl or an isophthaloyl,
   or said chain extender Y₁-A′-Y₁ bears a cyclic anhydride group Y₁, and preferably this extender is chosen from a cycloaliphatic and/or aromatic carboxylic dianhydride and more preferentially it is chosen from: ethylenetetracarboxylic dianhydride, pyromellitic dianhydride, 3,3′,4,4′-biphenyltetracarboxylic dianhydride, 1,4,5,8-naphthalenetetracarboxylic dianhydride, perylenetetracarboxylic dianhydride, 3,3′,4,4′-benzophenone tetracarboxylic dianhydride, 1,2,3,4-cyclobutanetetracarboxylic dianhydride, hexafluoroisopropylidene bisphthalic dianhydride, 9,9-bis(trifluoromethyl)xanthenetetracarboxylic dianhydride, 3,3′,4,4′-diphenylsulfonetetracarboxylic dianhydride, bicyclo[2.2.2]oct-7-ene-2,3,5,6-tetracarboxylic dianhydride, 1,2,3,4-cyclopentanetetracarboxylic dianhydride, 3,3′,4,4′-diphenyl ether tetracarboxylic dianhydride, or mixtures thereof
   and
when X₁ is COOH:
   said chain extender Y₁-A′-Y₁ corresponds to:
      Y₁ chosen from the groups: oxazoline, oxazine, imidazoline, aziridine, such as 1,1′-iso- or terephthaloyl-bis(2-methylaziridine) or epoxy,
      A′ being a carbon-based spacer (radical) as defined above.

More particularly, when, in said extender Y₁-A′-Y₁, said function Y₁ is chosen from oxazinone, oxazolinone, oxazine, oxazoline or imidazoline, in this case, in the chain extender represented by Y₁-A′-Y₁, A′ can represent an alkylene such as —(CH₂)ₘ— with m ranging from 1 to 14 and preferably from 2 to 10 or A′ can represent a cycloalkylene and/or an arylene which is substituted (alkyl) or unsubstituted, for instance benzenic arylenes, such as o-, m- or p-phenylenes, or naphthalenic arylenes, and preferably A′ is an arylene and/or a cycloalkylene.

In the case where Y₁ is an epoxy, the chain extender can be chosen from: bisphenol A diglycidyl ether (DGEBA), and its (cycloaliphatic) hydrogenated derivatives bisphenol F diglycidyl ether, tetrabromo bisphenol A diglycidyl ether, or hydroquinone diglycidyl ether, ethylene glycol diglycidyl ether, propylene glycol diglycidyl ether, butylene glycol diglycidyl ether, neopentyl glycol diglycidyl ether, 1,4-butanediol diglycidyl ether, 1,6-hexanediol diglycidyl ether, cyclohexanedimethanol diglycidyl ether, polyethylene glycol diglycidyl ether of Mn<500, polypropylene glycol diglycidyl ether of Mn<500, polytetramethylene glycol diglycidyl ether of Mn<500, resorcinol diglycidyl ether, neopentylglycol diglycidyl ether, bisphenol A polyethylene glycol diglycidyl ether of Mn<500, bisphenol A polypropylene glycol diglycidyl ether of Mn<500, diglycidyl esters of a dicarboxylic acid, such as terephthalic acid glycidyl ester, or epoxidized diolefins (dienes) or fatty acids with a double epoxidized ethylenic unsaturation, diglycidyl 1,2-cyclohexanedicarboxylate, and mixtures thereof.

Advantageously, X₁ is NH₂ or OH, in particular NH₂, and Y₁ is chosen from an oxazinone and an oxazolinone.

Advantageously, X₁ is CO₂H and Y₁ is chosen from an epoxy and an oxazoline.

Advantageously, X₁ is CO₂H and Y₁-A′-Y₁ is chosen from phenylene-bisoxazolines, preferably 1,3-phenylene-bis(2-oxazoline) or 1,4-phenylene-bis(2-oxazoline) (PBO).

In the case of carbonyl- or terephthaloyl- or isophthaloyl-biscaprolactam as chain extender Y₁-A′-Y₁, the preferred conditions avoid the elimination of by-product, such as caprolactam during said polymerization and processing in the molten state.

In the optional case mentioned above where Y₁ represents a blocked isocyanate function, this blocking can be obtained using agents for blocking the isocyanate function, for instance epsilon-caprolactam, methyl ethyl ketoxime, dimethylpyrazole, or diethyl malonate.

Likewise, in the case where the extender is a dianhydride which reacts with a prepolymer P(X)n where X₁═NH₂, the preferred conditions avoid any formation of an imide ring during the polymerization and during the processing in the molten state.

For X₁═OH or NH₂, the group Y₁ is preferably chosen from: isocyanate (nonblocked), oxazinone and oxazolinone, more preferentially oxazinone and oxazolinone, with, as spacer (radical), A′ which is as defined above.

As examples of chain extenders bearing oxazoline or oxazine reactive functions Y₁ that are suitable for the implementation of the invention, reference may be made to those described under references “A”, “B”, “C” and “D” on page 7 of application EP 0 581 642, and also to the processes for preparing same and the modes of reaction thereof which are disclosed therein. “A” in this document is bisoxazoline, “B” bisoxazine, “C” 1,3 phenylene bisoxazoline and “D” 1,4-phenylene bisoxazoline.

As examples of chain extenders bearing imidazoline reactive functions Y₁ that are suitable for the implementation of the invention, reference may be made to those described (“A” to “F”) on pages 7 to 8 and table 1 on page 10 of application EP 0 739 924, and also to the processes for preparing same and the modes of reaction thereof which are disclosed therein.

As examples of chain extenders with a reactive function Y₁=oxazinone or oxazolinone which are suitable for the implementation of the invention, reference may be made to those described under references “A” to “D” on pages 7 to 8 of application EP 0 581 641, and also to the processes for preparing same and the modes of reaction thereof which are disclosed therein.

As examples of oxazinone (6-atom ring) and oxazolinone (5-atom ring) groups Y₁ which are suitable, mention may be made of the groups Y derived from: benzoxazinone, from oxazinone or from oxazolinone, with, as spacer, A′ which can be a single covalent bond with respective corresponding extenders being: bis(benzoxazinone), bisoxazinone and bisoxazolinone.

A′ may also be a C₁ to C₁₄, preferably C₂ to C₁₀, alkylene, but preferably A′ is an arylene and more particularly it may be a phenylene (substituted with Y₁ in positions 1,2 or 1,3 or 1,4) or a naphthalene radical (disubstituted with Y₁) or a phthaloyl (iso- or terephthaloyl) or A′ may be a cycloalkylene.

For the functions Y₁ such as oxazine (6-membered ring), oxazoline (5-membered ring) and imidazoline (5-membered ring), the radical A′ may be as described above with A′ possibly being a single covalent bond and with the respective corresponding extenders being: bisoxazine, bisoxazoline and bisimidazoline. A′ may also be a C₁ to C₁₄, preferably C₂ to C₁₀, alkylene. The radical A′ is preferably an arylene and more particularly it may be a phenylene (substituted with Y₁ in positions 1,2 or 1,3 or 1,4) or a naphthalene radical (disubstituted with Y₁) or a phthaloyl (iso- or terephthaloyl) or A′ may be a cycloalkylene.

In the case where Y₁=aziridine (3-atom nitrogenous heterocycle equivalent to ethylene oxide with replacement of the ether —O— with —NH—), the radical A′ may be a phthaloyl (1,1-iso- or terephthaloyl) with, as an example of an extender of this type, 1,1′-isophthaloylbis(2-methylaziridine).

The presence of a catalyst of the reaction between said prepolymer P(X)n and said extender Y₁-A′-Y₁ in a content ranging from 0.001% to 2.0%, preferably from 0.01% to 0.5%, relative to the total weight of the two co-reactants mentioned, can accelerate the (poly)addition reaction and thus shorten the production cycle. Such a catalyst can be chosen from: 4,4′-dimethylaminopyridine, p-toluenesulfonic acid, phosphoric acid, NaOH and optionally those described for a polycondensation or transesterification as described in EP 0 425 341, page 9, lines 1 to 7.

According to a more particular case of the choice of said extender, A′ can represent an alkylene, such as —(CH₂)ₘ— with m ranging from 1 to 14 and preferably from 2 to 10, or represents an alkyl-substituted or unsubstituted arylene, such as benzenic arylenes (such as o-, m- or p-phenylenes) or naphthalenic arylenes (with arylenes: naphthalenylenes). Preferably, A′ represents an arylene which may be substituted or unsubstituted benzenic or naphthalenic.

As already specified, said chain extender (a2) has a non-polymeric structure and preferably a molecular weight of less than 500, more preferentially less than 400.

Said reactive prepolymers of said reactive composition a), according to the three options mentioned above, have a number-average molecular weight Mn ranging from 500 to 10 000, preferably from 1000 to 6000, in particular from 2500 to 6000. The Mns are determined in particular by calculation on the basis of the content of the end functions, determined by potentiometric titration in solution, and the functionality of said prepolymers. The weights Mn can also be determined by size exclusion chromatography or by NMR.

The content of said extender in said polymer derived from the reactive composition a), ranges from 1% to 20%, in particular from 5% to 20%.

In the case of the reactive compositions of the invention according to definition a), said reactive prepolymers are prepared by conventional polycondensation reaction between the diamine and corresponding diacid components and optionally (depending on the unit D) amino acids or lactams, while respecting the nature and proportions of the units A and B and optionally C and D according to the invention. The prepolymers bearing amine and carboxy functions X′ and Y′ on the same chain can be obtained, for example, by adding a combination of monomers (amino acid, diamine, diacid) having in total an equal amount of amine and carboxy units. Another route for obtaining these prepolymers bearing a function X′ and a Y′ is, for example, by combining a prepolymer bearing 2 identical functions X′=amine, with a diacid prepolymer bearing Y′: carboxy, with an overall molar content of acid functions equal to that of the starting amine functions X′.

To obtain prepolymers functionalized with identical (amine or carboxy) functions on the same chain, it is sufficient to have an excess of diamine (or of overall amine functions) to have amine end functions or an excess of diacid (or of overall carboxy functions) to have carboxy end functions.

In the case of a prepolymer P(X)n with n identical functions X₁, the functionality 1 can be obtained in the presence of a blocking monofunctional component (monoacid or monoamine depending on the nature of X₁=amine or carboxy).

A functionality n=2 can be obtained from difunctional components: diamines and diacids with excess of one to fix X₁ depending on this excess.

For n=3 for example, for a prepolymer P(X)n, the presence of a trifunctional component is necessary, for example the presence of a triamine (one mol per prepolymer chain) with a diamine in the reaction with a diacid. The preferred functionality for P(X)n is n=2.

The reinforcing fibers or fibrous reinforcement may be an assembly of fibers, preferably of long fibers, i.e. fibers having an aspect ratio defined by the ratio of length to diameter of the fiber, which means that these fibers have a circular cross-section, greater than 1000, preferably greater than 2000. The reinforcing fibers used may also be noncircular or a mixture of circular and noncircular fibers. In this assembly, the fibers may be continuous, or in unidirectional (UD) or multidirectional (2D, 3D) reinforcement form. In particular, they may be in the form of fabrics, sheets, strips or braids and may also be cut, for example in the form of nonwovens (mats) or in the form of felts.

These reinforcing fibers may be chosen from:
mineral fibers, said fibers having high melting temperatures Tm′ above the melting temperature Tm of said semicrystalline polyamide of the invention and higher than the polymerization and/or processing temperature;
polymeric fibers or polymer fibers having a melting temperature Tm′, or if not Tm′, a glass transition temperature Tg′, above the polymerization temperature or above the melting temperature Tm of said semicrystalline polyamide constituting said matrix of the composite and above the processing temperature;
or mixtures of the abovementioned fibers.

As mineral fibers suitable for the invention, mention may be made of carbon fibers, which includes fibers of nanotubes or carbon nanotubes (CNTs), carbon nanofibers or graphenes; silica fibers such as glass fibers, in particular of E, R or S2 type; boron fibers; ceramic fibers, in particular silicon carbide fibers, boron carbide fibers, boron carbonitride fibers, silicon nitride fibers, boron nitride fibers, basalt fibers; fibers or filaments based on metals and/or alloys thereof; fibers of metal oxides, in particular of alumina (Al₂O₃); metallized fibers such as metallized glass fibers and metallized carbon fibers, or mixtures of the abovementioned fibers.

More particularly, these fibers may be chosen as follows:
the mineral fibers may be chosen from: carbon fibers, carbon nanotube fibers, glass fibers, in particular of E, R or S2 type; boron fibers, ceramic fibers, in particular silicon carbide fibers, boron carbide fibers, boron carbonitride fibers, silicon nitride fibers, boron nitride fibers, basalt fibers, fibers or filaments based on metals and/or alloys thereof, fibers based on metal oxides such as Al₂O₃, metallized fibers such as metallized glass fibers and metallized carbon fibers, or mixtures of the abovementioned fibers, and
the polymer fibers or polymeric fibers, under the abovementioned condition, are chosen from:
   thermosetting polymer fibers and more particularly those chosen from: unsaturated polyesters, epoxy resins, vinyl esters, phenolic resins, polyurethanes, cyanoacrylates and polyimides, such as bismaleimide resins, or aminoplasts resulting from the reaction of an amine such as melamine with an aldehyde such as glyoxal or formaldehyde,
   thermoplastic polymer fibers, more particularly chosen from: polyethylene terephthalate (PET), polybutylene terephthalate (PBT), high-density polyolefins such as polyethylene (PET), polypropylene (PP) and PET/PP, PVOH (polyvinyl alcohol) copolymers,
   fibers of polyamides corresponding to one of the formulae: 6, 11, 12, 6.10, 6.12, 6.6 and 4.6,
   fibers of aramids (such as Kevlar®) and aromatic polyamides such as those corresponding to one of the formulae: PPD.T, MPD.I, PAA and PPA, with PPD and MPD being respectively p- et m-phenylenediamine, PAA being polyarylamides and PPA being polyphthalamides,
   fibers of polyamide block copolymers such as polyamide/polyether, fibers of polyaryl ether ketones (PAEKs) such as polyether ether ketone (PEEK), polyether ketone ketone (PEKK) or polyether ketone ether ketone ketone (PEKEKK).

The preferred reinforcing fibers are long fibers (with a circular cross-section) chosen from: carbon fibers, including those which are metallized, glass fibers, including those which are metallized, of E, R, S2 type, aramid fibers (such as Kevlar®) or aromatic polyamides, polyaryl ether ketone (PAEK) fibers, such as polyether ether ketone (PEEK) fibers, polyether ketone ketone (PEKK) fibers, polyether ketone ether ketone ketone (PEKEKK) fibers, or mixtures thereof.

The fibers that are more particularly preferred are chosen from: glass fibers, carbon fibers, ceramic fibers and aramid fibers (such as Kevlar®), or mixtures thereof. These fibers have a circular cross-section, in particular glass fibers.

Said fibers may represent contents of from 30.0% to 85.0% by weight, preferably from 50% to 80% by weight of said composite material, in particular from 50.0% to 75.0% by weight, in particular from 50.0% to 70.0% by weight of said composite material, in particular 50% by weight of said composite material.

The fiber assembly may be random (mat), unidirectional (UD) or multidirectional (2D, 3D, or the like). The grammage thereof, i.e. the weight thereof per square meter, can range from 100 to 1000 g/m², preferably from 200 to 700 g/m². The fibers may be in woven or nonwoven form, in particular in the form of reinforcing cloths and fabrics. They can in particular be assembled and linked in the form of a preform already having the shape of the final part. As suitable linking agent, use may be made of a composition according to a) or b) and, failing this, a linker compatible with said composition (composition a) or b)).

The composition according to the invention comprises a fibrous reinforcement based on fibers, preferably long fibers, in particular with L/D greater than 1000, preferably greater than 2000, and more particularly selected from glass fibers, carbon fibers, ceramic fibers, aramid fibers, or mixtures thereof.

More particularly, the composition according to the invention is a molding composition. As such, it may comprise, in addition to the reinforcing fibers, preferably long reinforcing fibers, other fillers and additives.

Among the suitable fillers, mention may for example be made of: inorganic or organic fillers: carbon black, carbon nanotubes (CNTs), carbon nanofibrils, glass beads, ground recycled polymers in powder form, and calcium carbonate.

Said fibers and fillers may represent contents of from 20.0% to 85.0% by weight, preferably from 30.0% to 85.0% by weight, more preferentially from 50.0% to 80.0% by weight of said composite material, in particular from 50.0% to 70.0% by weight of said composite material, in particular 50.0% by weight of said composite material, independently of the respective proportion of fibers and fillers.

Among the suitable additives, mention may be made of: additives which absorb in the UV or IR range so as to allow welding of the composite obtained, by a laser technology (UV or IR), and heat stabilizers chosen from antioxidants of sterically hindered phenol or sterically hindered amine (HALS) type. The function of these stabilizers is to prevent thermal oxidation and consequent photooxidation and degradation of the matrix polyamide of the composite obtained.

The composition of the invention may also comprise an impact modifier.

Examples of impact modifiers, without being limited thereto, are the following:

rubber, polybutadiene, polyisoprene, polyisobutylene, a copolymer of butadiene and/or of isoprene with styrene or styrene derivatives and other co-monomers, a hydrogenated copolymer, and/or a copolymer produced by grafting or copolymerization with anhydrides, of (meth)acrylic acid, or an ester thereof. The impact modifier may also be a rubber grafted with a crosslinked elastomer backbone which is composed of butadiene, of isoprene or of alkyl acrylates, and grafted with polystyrene, or may be a homopolymer or copolymer of an olefin which is nonpolar or polar, such as of ethylene-propylene, of ethylene-propylene-diene, or of ethylene-octene, or of ethylene-vinyl acetate, or a homopolymer or copolymer of an olefin which is nonpolar or polar, produced by grafting or copolymerization with anhydrides, of (meth)acrylic acid, or an ester thereof. The impact modifier may also be a functionalized carboxylic acid copolymer, such as poly (ethene-co-(meth)acrylic acid) or poly(ethene-co-1-olefin-co-(meth)acrylic acid), in which 1-olefin is an alkene or an unsaturated ester of (meth)acrylic acid having more than 4 atoms, including copolymers in which the acid groups have been neutralized with metal ions.

The impact modifier may be present in the composition at up to 30.0% by weight, preferentially from more than 5.0% to 20.0% by weight.

Advantageously, X₁ is CO₂H and Y₁ is chosen from an epoxy and an oxazoline.

The second subject of the invention relates to a process for manufacturing a thermoplastic composite material, in particular a mechanical part or a structural part based on said material, having a composition as defined according to the invention as set out above, which process comprises at least one step of polymerization of at least one reactive composition a) as defined above according to the invention or a step of molding or of processing at least one nonreactive composition b) as defined above according to the invention.

More particularly, said process can comprise the following steps:
i) melt impregnation of a fibrous reinforcement with a composition as defined above according to the invention but not comprising said fibrous reinforcement in an open or closed mold or outside the mold, in order to obtain a composition as defined according to the invention, i.e. with impregnated fibrous reinforcement,
ii) polymerization reaction by heating said composition of step i), in the case of a reactive composition a) of polyamide as defined according to the invention, with chain extension (increase in molecular weight), as appropriate, by polycondensation reaction (including self-condensation of the same prepolymer), or by bulk melt polyaddition reaction, with in the case of polycondensation, elimination under vacuum of the condensation products when a closed mold is involved, using a vacuum extraction system, if not and preferably with the polycondensation being carried out in an open mold or outside the mold,
iii) processing or molding of said composition of step i), in the case of a nonreactive polyamide composition b) as defined according to the invention, so as to form the final composite part in a mold or with another processing system, and in the case of a reactive composition a), a step of processing by molding or by means of another processing system and simultaneously with polymerization step ii).

In said process according to the invention, said processing can preferably be carried out according to an RTM, S-RIM, injection-compression molding or pultrusion process or by infusion molding, in particular in the case of a reactive composition a).

In said process according to the invention, said processing is carried out by thermocompression of pre-impregnates under reduced pressure.

Another subject of the invention relates to the use of a composition as defined above according to the invention or the use of a semicrystalline polyamide polymer according to the invention, for manufacturing a thermoplastic composite material, more particularly a mechanical part or a structural part (including structural and semi-structural part) based on said composition or on said composite material.

According to one more particular use, said mechanical parts or structural parts of said composite material concern applications in the motor vehicle, electrical or electronics, railway, marine and wind power fields, the photovoltaic field, the solar energy field, including solar panels and components of solar power stations, the sport field, the aeronautical and aerospace field, and the road transport (regarding trucks), construction, civil engineering, panel and leisure fields.

Advantageously, said parts for applications in the motor vehicle industry are parts under an engine hood for transporting fluid, in particular in air intake devices, cooling devices (cooling for example by air, cooling liquid, etc.), and devices for transporting or transferring fuels or fluids (such as oil, water, etc.).

Advantageously, said mechanical or structural parts for applications in the electrical or electronics industry are electrical and electronic goods, such as encapsulated solenoids, pumps, telephones, computers, printers, fax machines, modems, monitors, remote controls, cameras, circuit breakers, electrical cable jackets, optical fibers, switches or multimedia systems. These elements of electrical and electronic goods cover not only the structural parts of such goods (casings, housings, etc.), but also their optional associated accessories (earphones, connecting elements, cables, etc.).

More particularly, three more preferred applications can be distinguished according to the temperature at which said parts made of composite material according to the invention are used:
in the wind power industry, with a Tg of said thermoplastic matrix polyamide of at least 80° C., preferably of at least 90° C.
in the motor vehicle industry, with a Tg of said polyamide of at least 100° C.
in the aeronautical industry, with a Tg of said polyamide of at least 120° C.

This means that, for a Tg of at least 100° C., it can have two possible applications: automobile industry and wind power industry, and if the Tg is at least 120° C., it can have an application in the wind power and motor vehicle industries, in addition to the aeronautical industry.

The present invention also covers a thermoplastic composite material resulting from the use of at least one composition for thermoplastic composite material as defined above according to the present invention.

Lastly, the invention relates to a mechanical part or a structural part made of thermoplastic composite material, which results from the use of at least one composition of the invention as defined above or from the use of a semicrystalline polyamide polymer as defined according to the invention or of a thermoplastic composite material as defined above, or which part is obtained by means of a process as defined above according to the invention.

More particularly, said structural part is a motor vehicle part post-treated by cataphoresis, in particular with a Tg of at least 100° C.

According to another option, it is a part for wind power, in particular with a Tg of at least 80° C. and preferably of at least 90° C.

According to a third particular option, it is a part for the aeronautical industry, in particular with a Tg of at least 120° C.

### Methods for Determining the Characteristics Mentioned

The melting temperature Tm and the crystallization temperature Tc are measured by DSC, after a first heating/cooling/2nd heating cycle, according to standard ISO 11357-3:2013. The heating and cooling rate is 20° C./min.
The glass transition temperature Tg of the thermoplastic polymers used is measured using a differential scanning calorimeter (DSC), after a second heating pass, according to standard ISO 11357-2:2013. The heating and cooling rate is 20° C./min.
   A determination was made of the HDT (deflection temperature under load), according to standard ISO 75 f (bars placed flat) method A (load 1.8 MPa), heating temperature ramp 50° C.h⁻¹, of the HTg Pas 50% loaded with glass fibers (GF) at a temperature of the material of 290° C.
   The Mn of the thermoplastic prepolymer or polymer is determined on the basis of the titration (quantitative determination) of the end functions according to a potentiometric method (direct quantitative determination for NH₂ or carboxy) and on the basis of the theoretical functionality which is 2 (in terms of end functions) for linear prepolymers and polymers prepared from bifunctional monomers alone.
   The melt viscosity of the prepolymer or of the precursor composition is measured according to the reference manual of the constructor of the measuring instrument used, which is a Physica MCR301 Rheometer, under nitrogen flushing at the temperature given under a shear of 100 s⁻¹, between two parallel planes 50 mm in diameter.
   The measurement of the intrinsic or inherent viscosity is carried out in m-cresol. The method is well known to those skilled in the art. Standard ISO 307:2007 is followed, but with the solvent being changed (use of m-cresol instead of sulfuric acid), and the temperature being 20° C.
   The enthalpy of crystallization of said matrix polymer is measured by differential scanning calorimetry (DSC) according to standard ISO 11357-3:2013.

### EXAMPLES

### A—Preparation of a Polyamide Polymer Via the Direct Route (without Chain Extension of a Reactive Prepolymer)

5 kg of the following starting materials are placed in a 14-liter autoclave reactor:
500 g of water,
hexamethylenediamine and decanediamine,
the amino acid or the lactam,
terephthalic acid,
the monofunctional chain regulator: benzoic acid in an amount suitable for the Mn targeted and ranging (benzoic acids) from 40 to 100 g,
35 g of sodium hypophosphite in solution,
0.1 g of a Wacker AK1000 antifoam (the company Wacker Silicones).

The nature and molar ratios of the molecular units and structures of the polyamides (by reference test) are given in table 1 below.

The closed reactor is purged of its residual oxygen and then heated at a temperature of 230° C. with respect to the material introduced. After stirring for 30 minutes under these conditions, the pressurized vapor that has formed in the reactor is gradually reduced in pressure over the course of 60 minutes, while at the same time gradually increasing the temperature of the material such that it becomes established at Tm+10° C. at atmospheric pressure.

The polymerization is then continued under nitrogen flushing at 20 l/h until the targeted weight Mn indicated in the characteristics table is obtained.

The polymer is then emptied out by the bottom valve, then cooled in a waterbath and then granulated.

The results are presented in table 1 below.

TABLE 1
Characteristics of the polymers prepared via
the direct route without reactive prepolymer

| | | Molecular | | HDT A |
|---|---|---|---|---|
| | | structure/ | | (° C.) |
| | | Molar | Tm | With |
| Ref | Test type | composition | (° C.) | GF = 50% |
| 1 | Comparative | 10.T/6.T | 295 | 274 |
| | (EP1 988 113) | (50.1/49.9) | (IE2) | (IE11) |
| 2 | Invention | 10.T/6.T/11 | 269 | 218 |
| | | (61/24, 4/14, 6) | | |

GF = Glass fiber (% by weight)

The representative test 2 of the invention shows an HDT A that is much lower than that described for the 6T/10T (50.1/49.9) of patent EP 1 988 113 (IE 11) and in particular much lower than 260° C., and also a melting point lower than 270° C. (IE2).

Throughout the description, the Tg is determined according to standard 11357-2:2013 and the Tm, Tc and ΔH are determined according to standard 11357-3:2013.

### B—Preparation of a Polyamide Polymer by Chain Extension of a Reactive Prepolymer (or Oligomer)

### B-1 Preparation of the Reactive Prepolymer P(X)n

5 kg of the following starting materials are placed in a 14-liter autoclave reactor:
500 g of water,
Hexamethylene diamine and decanediamine,
the amino acid,
terephthalic acid,
35 g of sodium hypophosphite in solution,
0.1 g of a Wacker AK1000 antifoaming agent (Wacker Silicones).

The nature and molar ratios of the molecular units and structures of the reactive prepolymer polyamides (by reference test) are given in table 2 below.

The closed reactor is purged of its residual oxygen and then heated at a temperature of 230° C. of the material. After stirring for 30 minutes under these conditions, the pressurized vapor that has formed in the reactor is gradually reduced in pressure over the course of 60 minutes, while at the same time gradually increasing the temperature of the material such that it becomes established at Tm +10° C. at atmospheric pressure.

The oligomer (prepolymer) is then emptied out by the bottom valve and then cooled in a waterbath and then ground.

The characteristics are presented in table 2 below.

TABLE 2
Characteristics of the prepolymers prepared

| | | Molecular | | Mn |
|---|---|---|---|---|
| | | structure and | | g/mol |
| | | molar | Tm | (determined |
| Ref | | composition | (° C.) | by NMR) |
| 3 | According | 10.T/6.T/11 | 265 | 2635* |
| | to the | (63.6/27.3/9.1) | | |
| | invention | | | |
| 4 | According | 10.T/6.T/11 | 266 | 7117* |
| | to the | (63.6/27.3/9.1) | | |
| | invention | | | |
| 5 | According | 10.T/6.T/11 | 268 | 2701** |
| | to the | (63.6/27.3/9.1) | | |
| | invention | | | |
| 6 | According | 10.T/6.T/11 | 267 | 4545* |
| | to the | (60/24/16) | | |
| | invention | | | |
| 7 | According | 10.T/6.T/11 | 266 | 8333* |
| | to the | (60/24/16) | | |
| | invention | | | |
| 8 | According | 10.T/6.T/11 | 264 | 3407*** |
| | to the | (60/24/16) | | |
| | invention | | | |
| 9 | According | 10.T/6.T/11 | 261 | 2548** |
| | to the | (60/24/16) | | |
| | invention | | | |

*Reactive prepolymer bearing, on the same chain, two amine and carboxy or carboxy and amine functions X′ and Y′ as defined above.
**Prepolymer Di COOH bearing on the same chain two functions X′ and Y′ = COOH.
***Prepolymer Di NH₂ bearing on the same chain two functions X′ and Y′ = NH₂.

### B-2 Preparation of the Polyamide Polymer by Chain Extension with an Extender of Y-A-Y Type

10 g of the dried and ground above oligomer (in this example, that of table 2, Ref. 5) are mixed with a stoichiometric amount of 1,3-phenylene-bis(2-oxazoline) (PBO). The mixture is introduced under nitrogen flushing into a DSM co-rotating conical screw microextruder (15 ml volume) preheated to 280° C., with rotation of the screws at 100 rpm. The mixture is left to recirculate in the microextruder and the increase in viscosity is monitored by measuring the normal force. After approximately 2 minutes, a plateau is reached and the contents of the microextruder are emptied out in the form of a rod. The air-cooled product is formed into granules.

The results of the product analyses are presented in table 3 below.

TABLE 3
Analytical characteristics of the polyamides obtained with chain extension

| | | Molecular | | | | | Inherent | Mn (determined |
|---|---|---|---|---|---|---|---|---|
| | | structure/Molar | Tm | Tg | Tc | ΔH | viscosity | by size exclusion |
| Ref | | composition | (° C.) | (° C.) | (° C.) | (J/g) | (in m-cresol) | chromatography) |
| 10 | According | 10.T/6.T/11 | 263 | 114 | 224 | 46 | 1.38 | 12 600 |
| | to the | (63.6/27.3/9.1) | | | | | | |
| | invention | | | | | | | |

### C—Composite Formulation Comprising Short Fibers

### C-1 Preparation of the Formulation

The granules resulting from step A are compounded on an Evolum 32 twin-screw extruder according to a flat temperature profile of 280° C. The flow rate is 40 kg/h and the speed is 300 rpm. The polymer (49.65% by weight) and the additives (0.3% of calcium stearate and 0.4% of Irganox 1010) are introduced into the main hopper. The Asahi CS 692FT glass fiber (49.65% by weight) is introduced via side feeder in the second part of the extruder. The rods are cooled in water and granulated.

The results of the analyses of the products obtained are presented in table 4 below.

TABLE 4
Characteristics obtained for the formulations used

| | | Molar | |
|---|---|---|---|
| | | composition of | Tm |
| Ref | | the polymer | (° C.) |
| 2 | According to | 10.T/6.T/11 | 269 |
| | the invention | (61/24.4/14.6) | |

1. A composition for thermoplastic composite material or composition of thermoplastic composite material, said composite material comprising reinforcing fibers or fibrous reinforcement and a thermoplastic matrix impregnating said fibers, said matrix being based on at least one thermoplastic polymer, said composition being wherein said matrix thermoplastic polymer is a semicrystalline polyamide polymer comprising amide units Z, 10T and 6T;
said composition comprising, in addition to said reinforcing fibers:
a) a reactive composition comprising or consisting of at least one reactive polyamide prepolymer or oligomer, said composition being a precursor composition of said polyamide polymer of said matrix,
or as an alternative to a)
b) a nonreactive composition of at least one polyamide polymer, including the polymer derived from the reactive composition a), said composition being that of said thermoplastic matrix, and with:
said composition a) or b) comprising or consisting of one or more polyamides, including random or block copolyamides which are prepolymers or oligomers according to a) or which are polymers according to b) and which comprise amide units Z, 10T and 6T, selected as follows:
Z corresponding to an amide unit resulting:
from the condensation of at least one C₆-C₁₄ amino acid or lactam,
from the condensation of a diamine and of a diacid X.Y, X and Y being of C₄-C₁₈,
the molar content of Z being: 0.0<Z<30.0%,
10T being a major amide unit, resulting from the condensation of a C₁₀ diamine, and of terephthalic acid, present in a molar content ranging from 40.0% to 95.0%,
6T being an amide unit, resulting from the condensation of a C₆ diamine, and of terephthalic acid, present in a molar content ranging from 5.0% to 60.0%,
and under the condition that the sum of the molar contents Z+10T+6T is equal to 35 to 100%, said composition having a deflection temperature under load (HDT A) below 260° C., and a melting temperature Tm of less than or equal to 270° C.

2. The composition as claimed in claim 1, wherein the polyamide polymer is chosen from 6/10T/6T, 12/10T/6T or 11/10T/6T.

3. The composition as claimed in claim 1, wherein the polyamide polymer is chosen from 10.10/10T/6T, 12.10/10T/6T, 10.12/10T/6T and 12.12/10T/6T.

4. The composition as claimed in claim 1, wherein the molar proportion of the unit Z is included from 5.0% to 20.0%.

5. The composition as claimed in claim 1, wherein the molar proportion of 10T is included from 55.0% to 65.0%.

6. The composition as claimed in claim 1, wherein the molar proportion of 6T is included from 15.0% to 60.0%.

7. The composition as claimed in claim 1, wherein the polyamide polymer of the invention is 11/10T/6T in which the proportion of unit 11 is included from 5.0% to 20.0%, the proportion of 10T is included from 55.0% to 65.0%, and the proportion of 6T is included from 15.0% to 60.0%.

8. The composition as claimed in claim 1, wherein said polyamide composition is a nonreactive composition according to b).

9. The composition as claimed in claim 1, wherein said polyamide composition is a reactive prepolymer composition according to a) and precursor of said polyamide polymer of said matrix of the composite.

10. The composition as claimed in claim 9, wherein said composition a) comprises or consists of at least one reactive prepolymer bearing, on the same chain, two end functions X′ and Y′, said functions being respectively coreactive with one another by condensation, with X′ and Y′ being amine and carboxy or carboxy and amine, respectively.

11. The composition as claimed in claim 9, wherein said reactive composition a) comprises at least two polyamide prepolymers which are reactive with one another and which each respectively bear two identical end functions X′ or Y′, said function X′ of a prepolymer being able to react only with said function Y′ of the other prepolymer.

12. The composition as claimed in claim 9, wherein said composition a) or precursor composition comprises or consists of:
a1) at least one prepolymer of said thermoplastic polyamide polymer, bearing n end reactive functions X₁, chosen from: —NH₂, —CO₂H and —OH, with n being 1 to 3,
a2) at least one chain extender Y₁-A′-Y₁, with A′ being a hydrocarbon-based biradical of non-polymeric structure, bearing 2 identical end reactive functions Y, reactive by polyaddition with at least one function X₁ of said prepolymer a1).

13. The composition as claimed in claim 9, wherein said reactive prepolymers of said composition a) have a number-average molecular weight Mn ranging from 500 to 10 000.

14. The composition as claimed in claim 9, wherein X₁ is NH₂ or OH, and Y1 is chosen from an oxazinone and an oxazolinone.

15. The composition as claimed in claim 9, wherein X₁ is CO₂H and Y₁ is chosen from an epoxy and an oxazoline.

16. The composition as claimed in claim 15, wherein X₁ is CO₂H and Y₁-A′-Y₁ is chosen from phenylene-bisoxazolines.

17. The composition as claimed in claim 1, wherein the composition comprises a fibrous reinforcement with long fibers.

18. The composition as claimed in claim 1, wherein the composition is a molding composition.

19. A polymer derived from a prepolymer and from a chain extender, as defined in claim 12.

20. A process for manufacturing a thermoplastic composite material, having a composition as defined in claim 1, wherein the composition comprises at least one step of polymerization of at least one reactive composition a) or a step of molding or of processing at least one nonreactive composition b).

21. The process as claimed in claim 20, wherein the composition comprises the following steps:
i) melt impregnation of a fibrous reinforcement with said composition but not comprising said fibrous reinforcement, in an open or closed mold or outside the mold, in order to obtain said composition,
ii) polymerization reaction in the case of a reactive composition a) of polyamide, by heating said composition of step i) with chain extension, as appropriate, by polycondensation reaction, or by bulk melt polyaddition reaction, with in the case of polycondensation, elimination under vacuum of the condensation products when a closed mold is involved, using a vacuum extraction system, if not with the polycondensation being carried out in an open mold or outside the mold,
iii) processing or molding of said composition of step i), in the case of a nonreactive polyamide composition b), so as to form the final composite part in a mold or with another processing system, and in the case of a reactive composition a), a step of processing by molding or by means of another processing system and simultaneously with polymerization step ii).

22. The process as claimed in claim 21, wherein said processing is carried out according to an RTM, S-RIM, injection-compression molding or pultrusion process or by infusion molding.

23. The process as claimed in claim 22, wherein said processing is carried out by thermocompression of pre-impregnates under reduced pressure.

24. The use of a composition as defined in claim 1, for manufacturing mechanical or structural parts based on said composite material.

25. The use as claimed in claim 24, wherein said mechanical or structural parts of said composite material concern applications in the motor vehicle, electrical and electronics, railway, marine and wind power fields, the photovoltaic field, the solar energy field, including solar panels and components of solar power stations, the sport field, the aeronautical and aerospace field, and the road transport, construction, civil engineering, panel and leisure fields.

26. The use as claimed in claim 25, wherein the use concerns applications in the wind power field and in that said Tg of said polyamide is at least 80° C.

27. The use as claimed in claim 25, wherein the use concerns applications in the motor vehicle field and in that said Tg of said polyamide is at least 100° C.

28. The use as claimed in claim 25, wherein the use concerns applications in the aeronautical field and in that said Tg of said polyamide is at least 120° C.

29. A thermoplastic composite material, wherein the composite material results from the use of at least one composition for thermoplastic composite material as defined in claim 1.

30. A mechanical or structural part made from thermoplastic composite material, wherein the part results from the use of at least one composition as defined in claim 1.

31. The structural part as claimed in claim 30, wherein the part is a motor vehicle part post-treated by cataphoresis.

32. The part as claimed in claim 30, wherein the part is a part for wind power.

33. The part as claimed in claim 30, wherein the part is a part for the aeronautical industry.
